(19) United States
(12) Patent Application Publication
(10) Pub. No.: US 2023/0345455 A1
(43) Pub. Date: Oct. 26, 2023

(54) CONTROL OF UPLINK TRANSMISSION FOR ERROR ESTIMATION

(71) Applicant: Sony Group Corporation, Tokyo (JP)

(72) Inventors: Basuki PRIYANTO, Lund (SE); Nafiseh Seyed MAZLOUM, Lund (SE)

(21) Appl. No.: 17/796,421

(22) PCT Filed: Feb. 3, 2021
(86) PCT No.: PCT/EP2021/052562

§ 371 Date: Jul. 29, 2022

(30) Foreign Application Priority Data
Feb. 14, 2020 (SE) 2050168-0

(51) Int. Cl. H04W 72/1263; H04L 5/00; H04L 5/14

(52) U.S. Cl. CPC H04W 72/1263; H04L 5/0048; H04L 5/14

(57) ABSTRACT

A method for controlling uplink, UL, transmission, carried out in a user equipment, UE, comprising a radio unit configured for communication with a wireless network, comprising receiving information from the wireless network, which information identifies scheduling of one or more downlink, DL, reference signals, usable for estimating a time and/or frequency error of the radio unit; receiving, from the wireless network, scheduling of an UL transmission pattern; wherein the information indicates timing of a first reference signal prior to or during the scheduled transmission pattern.

### FIELD OF THE INVENTION

This disclosure presents solutions for control of uplink transmission in a wireless system, so as to optimize the possibility of error estimation in a user equipment. The solution involves both methods and devices to this avail.

### BACKGROUND

Electronic devices often include wireless communications circuitry, and such electronic devices may be referred to as wireless terminals. For example, cellular telephones, computers, and other devices often contain antennas and wireless transceivers for supporting wireless communications. In 3GPP (The 3rd Generation Partnership Project) documentation, a wireless terminal, or wireless communication device, is commonly referred to as a User Equipment (UE). This term will be used herein but shall not be construed as being limited to operation under 3GPP specifications.

In a wireless communication system, a base station defines a cell and is operative to serve a surrounding area with radio access for UEs, by providing radio access to UEs within the cell. A base station may also be referred to as an access node, and various terms are used in 3GPP for different types of systems or specification. An access network, or Radio Access Network (RAN), typically includes a plurality of access nodes, and is connected to a Core Network (CN) which inter alia provides access to other communication networks. In the so-called 3G specifications, the term NodeB is used to denote an access node, whereas in the so-called 4G specifications, also referred to as Long-Term Evolution (LTE), the term eNodeB (eNB) is used. A further developed set of specifications for radio communication are referred to as the 5G type radio communication system (5GS), including the New Radio (NR) technology, wherein the term gNB is used to denote an access node.

Many types of wireless terminals are most frequently used for reception of data from the wireless network in downlink (DL), such as for streaming or downloading of data. However, for certain applications, uplink (UL) transmission of data is a usable feature. This may e.g. be related to live upload of streaming video data, as captured by a video camera device. Some other applications may require simultaneous DL and UL transmission of data, such as video teleconference.

As wireless system technology progresses, both networks and UEs become increasingly sophisticated and capable, related to e.g. bandwidth, data transfer rates and services provided. However, the need for non-complex services or services with requirements that are lower than what the system actually supports, still remains. For such purposes, 3GPP have inter alia implemented Machine Type Communications (MTC) and a corresponding class of UEs, referred to as MTC device, as well as specific features to support efficient MTC, have been defined on both the network side and the UE side. A variant of MTC is referred to as NB-IoT (Narrow Band Internet of Things), developed to enable low-cost and/or low complexity radio devices with low-power consumption and extended coverage. Such effects are achieved by limiting the MTC or NB-IoT devices with respect to their capability to utilize the full bandwidth and high data rates supported by e.g. LTE radio technology. For example, an MTC device may be operated in a narrow frequency band of 1.4 MHz. This operation is also referred to as narrowband LTE. In the case of NB-IoT (Narrow Band Internet of Things), the utilized bandwidth can be even as small as 200 kHz. Even in the context of NR release 17, a UE with reduced capability will be introduced in order to reduce the cost and power consumption and/or to support a UE with specific/dedicated use-cases.

In various instances of wireless communication, the UE may be configured to transmit according to a transmission pattern which involves numerous uplink transmit occasions. This may for instances be the case for communication services that are operated using limited bandwidth resources, such as the aforementioned examples. In order for the UE to transmit with enough energy to convey its data with the desired coverage, it may be configured to carry out repeated transmission in a number of transmission repetitions. Another example is so called semi-persistent scheduling (SPS), a technique which has been used for a transmission with a fixed pattern and/or payload for certain duration of time, such as voice over IP (VoIP) based services, for allocating UL resources. The result may be extended transmit sequences when using such techniques.

To reduce cost and complexity of UEs configured for such lower requirement services, the UE may use low cost oscillators, e.g., a Digital Controlled Crystal Oscillator (DCXO) or free-running crystal oscillator (XO), as a local oscillator or more generally a frequency reference source for operating the radio receiver/transmitter. However, such low cost oscillators may have more imperfections than more accurate and costly oscillators. For example, the oscillators may be limited with respect to the stability of their output frequency over temperature. Furthermore, in order to reduce the UE cost and complexity, a UE may operate with Half-Duplex operation. In this case, the UE only need to have one transmission chain to be alternately used for uplink or downlink.

In the context of transmission patterns requiring extended UL transmission, there is a need for techniques that allow for efficient estimation of frequency errors of time or frequency, such as of a reference frequency source. This may be particularly challenging for UEs operating at narrowband channels which may require changing frequency to obtain DL signals, or even supporting only half-duplex transmission which means that they are not capable of receiving and transmitting at the same time.

### SUMMARY

In view of these needs and challenges, solutions are presented in the independent claims, whereas embodiments are set out in the dependent claims and in the following description.

The proposed solutions involve a method for controlling uplink, UL, transmission, carried out in a user equipment, UE, comprising a radio unit configured for communication with a wireless network, comprising
receiving information from the wireless network, which information identifies scheduling of one or more downlink, DL, reference signals, usable for estimating a time and/or frequency error of the radio unit;
receiving, from the wireless network, scheduling of an UL transmission pattern;
wherein the information indicates timing of a first reference signal prior to or during the scheduled transmission pattern.

This way, it may be ensured that the UE is appropriately synchronized based on estimation of frequency or time errors.

In various embodiments, the solutions include a mechanism for the UE to configure its UL transmission based on the first reference signal having a timing during the scheduled transmission pattern, and thus colliding with the intended UL transmission pattern. Based on one or more rules, the UE may in various embodiments be configured to either drop or postpone UL transmission. This way, the UE may be configured to handle collision in a manner which ensures that the UE is appropriately synchronized based on estimation of frequency or time errors.

In various other embodiments, the solutions include a mechanism for scheduling the first reference signal as an aperiodic reference signal prior to the scheduled transmission pattern. Based on one or more rules, the need for such an aperiodic reference signal may be determined and scheduled by the network. This way, the UE may be appropriately synchronized based on estimation of frequency or time errors in scenarios when periodic reference signals may be too far apart or with limited resources to obtain proper synchronization.

### BRIEF DESCRIPTION OF THE DRAWINGS

FIG. 1 schematically illustrates a wireless network and communication between a UE and a base station of the wireless network according to various embodiments.

FIG. 2 schematically illustrates a UE configured to operate according to various embodiments.

FIG. 3 schematically illustrates a base station configured to operate according to various embodiments.

FIG. 4 schematically illustrates resource allocation for half-duplex communication between a UE and a base station:

FIG. 5 schematically illustrates configuration of uplink communication dependent on reference signal scheduling in downlink according to various embodiments.

FIG. 6 schematically illustrates a signaling diagram of various embodiments.

FIG. 7 schematically illustrates a signaling diagram of various embodiments.

FIG. 8 schematically illustrates scheduling of an aperiodic downlink reference signal according to an embodiment of half-duplex FDD.

FIG. 9A schematically illustrates scheduling of an aperiodic downlink reference signal according to an embodiment of TDD.

FIG. 9B schematically illustrates scheduling of an aperiodic downlink reference signal according to another embodiment of TDD.

FIG. 10A schematically illustrates an uplink transmission pattern comprising transmission repetition.

FIG. 10B schematically illustrates an uplink transmission pattern comprising semi-persistent scheduling.

FIG. 10C schematically illustrates an uplink transmission pattern comprising semi-persistent scheduling with transmission repetition.

### DETAILED DESCRIPTION

In the following description, for purposes of explanation and not limitation, details are set forth herein related to various embodiments. However, it will be apparent to those skilled in the art that the present invention may be practiced in other embodiments that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

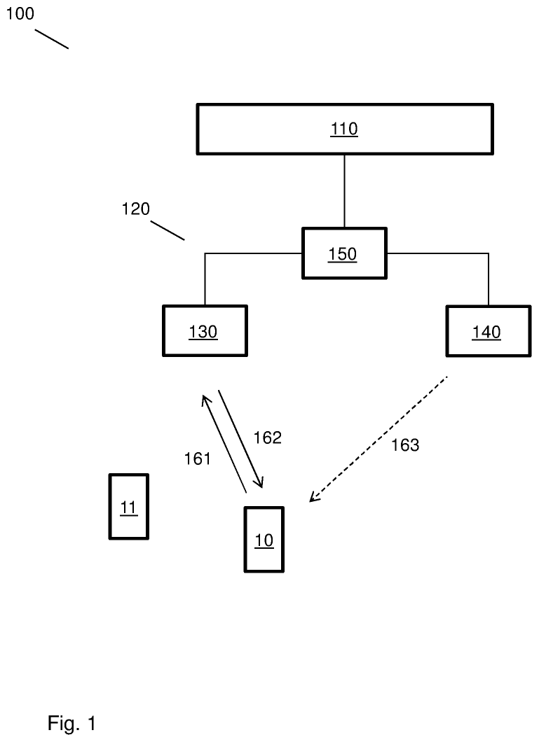

FIG. 1 schematically illustrates a wireless communication system, providing an example of a scenario of wireless communication in which the solutions provided herein may be incorporated. The wireless communication system includes a wireless network 100, and a UE (or terminal) 10 configured to wirelessly communicate with the wireless network 100. The wireless network may be a radio communication network operating under general and specific regulations and limits published by the 3GPP, such as a New Radio (NR) network. The wireless network 100 may include a core network 110, which is connected to other networks, such as the Internet. The wireless network 100 further includes an access network 120, which comprises a plurality of base stations or access nodes 130, 140 and one or more nodes 150 controlling communication in the access network 120 and with the core network 110, e.g. for handling user plane functionality and mobility management of UEs. A base station is an entity executing the wireless connection with UEs. As such, each base station 130, 140 may comprise or be connected to an antenna arrangement for transmitting and receiving radio signals. The actual point of transmission and reception of the base station may be referred to as a Transmission and Reception Point (TRP), which may be seen as a network node which includes or is co-located with an antenna system of the base station 130, 140.

The UE 10 may be any device operable to wirelessly communicate with the network 100 through the base station 130, 140, such as a mobile telephone, computer, tablet, a M2M device, an IoT device or other.

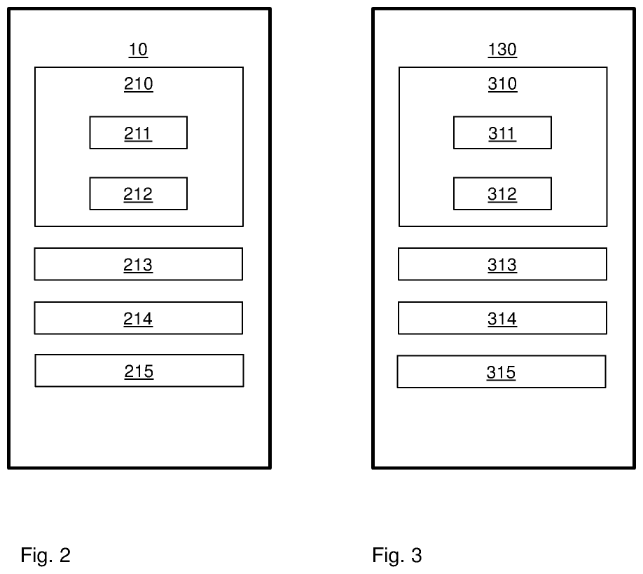

FIG. 2 schematically illustrates an embodiment of the UE 10 for use in a wireless network 100 as presented herein, and for carrying out the method steps as outlined.

The UE 10 may comprise a radio unit 213 comprising a radio transceiver for communicating with other entities of the radio communication network 100, such as the base stations 130, 140, in different frequency bands. The radio unit 213 may thus include a radio receiver and transmitter for communicating through at least an air interface.

The UE 10 further comprises logic 210 configured to communicate data, via the radio unit, on a radio channel, to the wireless communication network 100 and possibly directly with another terminal by Device-to Device (D2D) communication.

The logic 210 may include a processing device 211, including one or multiple processors, microprocessors, data processors, co-processors, and/or some other type of component that interprets and/or executes instructions and/or data. Processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic 210 may further include memory storage 212, which may include one or multiple memories and/or one or multiple other types of storage mediums. For example, memory storage 212 may include a random access memory (RAM), a dynamic random access memory (DRAM), a cache, a read only memory (ROM), a programmable read only memory (PROM), flash memory, and/or some other type of memory. Memory storage 212 may include a hard disk (e.g., a magnetic disk, an optical disk, a magneto-optic disk, a solid state disk, etc.).

The memory storage 212 is configured for holding computer program code, which may be executed by the processing device 211, wherein the logic 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic 210. The UE 10 may further comprise, or be connected to, an antenna 214, which may include an antenna array.

The UE 10 may further comprise a frequency reference source 215 for operating the radio transceiver 213, such as a Digital Controlled Crystal Oscillator (DCXO) or free-running crystal oscillator (XO), as a local oscillator.

Obviously, the UE 10 may include other features and elements than those shown in the drawing or described herein, such as a power supply, a casing, a user interface, one or more sensors etc.

FIG. 3 schematically illustrates a base station 130 for use in a radio communication network 100 as presented herein, and for carrying out the method steps as outlined herein. It shall be noted that the embodiment of FIG. 3 may equally well be used for the second base station 111.

The base station 130 includes or operates as a base station of a radio communication network 100, such as a gNB. The base station 140 may be configured in the same way as the base station 130.

The base station 130 may comprise a radio transceiver 313 for wireless communicating with other entities of the radio communication network 100, such as the UE 10. The transceiver 313 may thus include a radio receiver and transmitter for communicating through at least an air interface.

The base station 130 further comprises logic 310 configured to communicate data, via the radio transceiver, on a radio channel, with UE 10. The logic 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the base station 130 to carry out any of the method steps as provided herein. Software defined by said computer program code may include an application or a program that provides a function and/or a process. The software may include device firmware, an operating system (OS), or a variety of applications that may execute in the logic 310.

The base station 130 may further comprise or be connected to an antenna 314, connected to the radio transceiver 313, which antenna may include an antenna array.

The base station 130 may further comprise a communication interface 316, operable for the base station 130 to communicate with other nodes of the wireless network 100, such as a higher network node 150 or with another base station 140.

The logic 310 is configured to determine allocation of resources to UEs operating within the cell of the base station 130, based on inter alia BSR received from such UEs, and to transmit information of resource allocation to the UEs.

In various embodiments, the base station 130 is configured to carry out the method steps described for execution in a base station as outlined herein. Various embodiments will now be described with reference to the drawings.

Returning to FIG. 1, the wireless network 100 may be operated as a cellular network. Specifically, FIG. 1 shows the UE 10 being operated in a connected mode with the base station 130, wherein the UE 10 may receive downlink (DL) signals 162 from the base station 130. These DL signals may for example include a broadcast channel conveying at least parts of system information of the radio technology operated by the base station 130. Alternatively, or in addition, the DL signals 162 may include a control channel, a data channel, and signals to assist those channels. The DL signals may e.g. include synchronization signals and reference signals such as CRS (Common Reference Signal). The control channel may be a PDCCH (Physical Downlink Control Channel). The data channel may be a PDSCH (Physical Downlink Shared Channel). On the basis of such DL signals 162, the UE 10 can access the cell of the base station 130 and send 162 UL messages to the base station 130, and/or receive 161 messages from the base station 130, e.g. on a PUSCH (Physical Uplink Shared Channel) or NB-PUSCH or PRACH (Physical Random Access Channel) or PUCCH (Physical Uplink Control Channel). UL messages may be conveyed in one or more transport blocks defined on a physical layer and may contain data.

In NR the wireless communication system has been designed to support lean carrier transmission. Unlike 4G LTE, where the CRS is transmitted with the periodicity of around 0.3 ms, NR only has synchronization signal block (SSB) which can be transmitted every 20 ms. The SSB is used during initial access for cell identification, and for synchronization and measurement. Moreover, NR supports a reference signal for time and frequency synchronization purpose, known as Tracking Reference Signal (TRS). TRS is a UE-specific reference signal that is transmitted by the base station (gNB) periodically when the UE is in connected mode. TRS in NR has different periodicity options of 10 ms, 20 ms, 40 ms, or 80 ms.

The existing NR up to release 16 specifies both full duplex Frequency Division Multiplex (FD-FDD) and Time Division Multiplex (TDD) operation. Due to the identified need of NR UEs with lower capability, Half-Duplex (HD) FDD is now being considered.

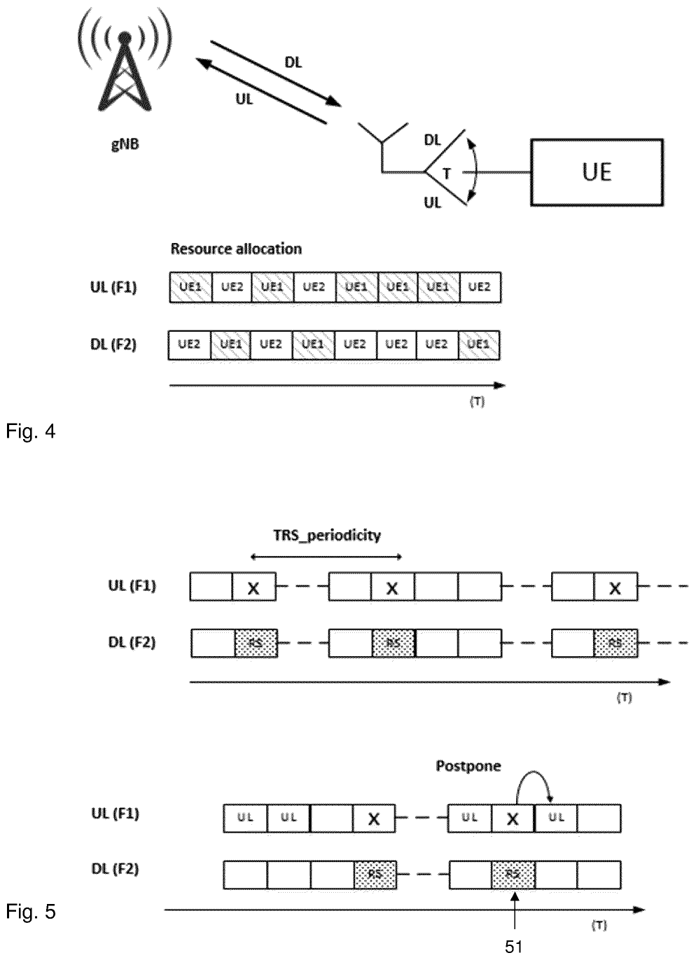

FIG. 4 schematically illustrates HD-FDD operation. In such operation, the UE may be used for either transmission in UL or reception in DL and is thus operated to switch between a UL and a DL setting, for communication with the gNB base station. Where the base station 130 serves more than one UE, such as a UE 10 (UE1) and UE 11 (UE2) in FIG. 1, UL resources may e.g. be allocated to one device UE1 while DL resources are allocated to the other device UE2.

NR UEs with lower capability are also considered, targeting a device with e.g. lower number of antennas resulting in lower antenna gain, especially in higher frequencies such as FR2, maybe as much as 6-10 dB lower than a legacy NR UE. In order to compensate for the lower antenna gain and still being configured to maintain the same coverage, it may be expected that signal transmission with repetition is introduced, similar to MTC. Furthermore, UEs with reduced capability may furthermore have limited bandwidth, compared to a legacy NR UE.

In legacy NR that operates with full duplex (FD) operation, the UE can receive the mentioned DL signals, such as SSB and TRS, while the UE performs UL transmission, i.e. in connected mode. Hence, the UE can make use of the obtained DL signals to estimate and/or control synchronization. However, with a UE with reduced capability, which may be beneficial to e.g. reduce the cost and power consumption and/or to support a UE with specific/dedicated use-cases, such as IoT, estimating and/or controlling synchronization may be more challenging. This may e.g. be the case during HD operation, wherein during UL transmission, the UE may not concurrently receive neither SSB nor TRS which are typically used for synchronization purpose. This implies that the UE may not be able to correct a frequency error introduced by e.g. the instability of a local oscillator in the UE. This may in turn degrade the quality of the transmitted UL signal.

Herein, various mechanisms are proposed to prevent the above situation by ensuring the UE is scheduled to be able to receive synchronization and/or reference signals. The proposed mechanisms are mainly intended for use in connected mode but may be relevant for initial access as well. The proposed solution involves various methods for a UE configured to operate in with HD-FDD or TDD, which methods are arranged to ensure reception of a reference signal in order to maintain the synchronization. The solutions solve the problem in various different ways and are suitable in different situations.

On a general level, and from the aspect of the UE 10, a solution is proposed by means of a method for controlling uplink, UL, transmission, carried out in a UE 10, comprising a radio unit 213 configured for communication with a wireless network 100. The general method comprises receiving information from the wireless network, which information identifies scheduling of one or more downlink, DL, reference signals, usable for estimating a time and/or frequency error of the radio unit;
receiving, from the wireless network, scheduling of an UL transmission pattern;
wherein the information indicates timing of a first reference signal prior to or during the scheduled transmission pattern.

In various embodiments, said first reference signal is a periodic reference signal, and in one of those embodiments the first reference signal is a periodic TRS or similar.

FIG. 5 illustrates an embodiment of a HD-FDD scenario, indicating resources for UL at a first frequency F1 and resources for DL at a second frequency F2. With a certain periodicity a reference signal RS is transmitted in the DL from the base station 130, such as a base station serving the UE 10 in connected mode. As indicated in this example, the reference signal is a TRS. The scheduling of the TRS is provided specifically for the UE 10, though it need not be unique for that UE 10, and the scheduling is obtained in the UE 10 from said received information. As indicated in the uppermost part of FIG. 5, the UE 10 may be configured to adapt its radio unit 213 to the reference signal scheduling so as to be able to receive the reference signal RS. For this reason, since the UE 10 is configured for HD-FDD, transmission in the UL is inhibited in the corresponding time slots, as indicated by X in the drawing. In practice, X duration may not only comprise the TRS time-slot(s), but also the required time to switch to TRS reception and/or time to switch from TRS reception to UL transmission. The switching time can be called as the guard period for half-duplex operation (GP). This configuration that transmission is inhibited in the time slots scheduled to reference signals RS may be based on e.g. type, UE capability, UE category, or power class of the UE 10, and/or the period of the reference signal. For example, the reference signal period (e.g. TRS period) may be configured by the base station 130 based on conveyed capability data, such that the period does not exceed a frequency estimation period for frequency correction of the UE 10, as identified by, or determined based on, the UE capabilities. In various scenarios, which are alternative to the one shown in FIG. 5, the reference signal period may be shorter that the required minimum period for obtaining reference signals in the UE 10 for frequency correction, and the UE 10 may then be configured to not inhibit transmission at every reference signal occasion.

As illustrated in the lower part of FIG. 5, the UE 10 has received scheduling of an UL transmission pattern which identifies UL transmission in two consecutive time slots at the beginning of a periodic UL transmission timeframe. In the drawing, four time slots are indicated for each timeframe of the periodic UL transmission in two consecutive time slots, but these numbers are just examples for illustration purposes. Furthermore, UL transmission pattern can also be just a single UL transmission with N-time repetitions. In the drawing, there are two independent UL transmission and each UL transmission in two consecutive time slots.

In the example of the first occasion of UL transmission according to the scheduled UL transmission pattern (to the left in the drawing), both slots may be used since they do not collide with a reference signal RS. However, in the example of the second occasion of UL transmission according to the scheduled UL transmission pattern (to the right in the drawing), the second slot collides with a scheduled reference signal RS, meaning that the received information indicates timing 51 of a first reference signal during the scheduled transmission pattern. In such a scenario, the UE 10 may be configured to resolve the situation in various ways, as identified by the examples provided below, wherein the UE 10 is arranged to drop or postpone its UL transmission if the uplink transmission timing is colliding with the reception of reference signals, such as TRS and/or periodic SSB.

In one embodiment, the UE 10 is configured to drop UL transmission according to the scheduled transmission pattern, responsive to the timing 51 of the first reference signal occurring during the scheduled transmission pattern. This may in various embodiments include dropping all repetitions of the transmission pattern, responsive to the UE 10 receiving the information identifying the scheduling of the first reference signal prior to initiating UL transmission according to the transmission pattern, and thus obtaining the information that the scheduled first reference signal will be colliding with the scheduled transmission pattern.

The decision to drop UL transmission may be dependent on one or more parameters, e.g. a number of scheduled or required UL repetitions. In one embodiment, the UE 10 drops UL transmission if the UL transmission is without repetition (R=1), i.e. discards this possibility to transmit. In one embodiment, if a number of repetitions are scheduled in time slots after the timing 51 of the first reference signal, and that number exceeds a predetermined value, such as 1, 2, 5, 10 or more, the UE may be configured to drop transmission as predetermined rule. This predetermined rule may be based on the underlying knowledge or assumption that further frequency or time estimation and/or correction will be required to successfully transmit said remaining repetitions. When UL transmission is dropped, the base station 130 is configured to allocate a new UL transmission later on. This way, the UE 10 is adapted to handle a collision based on the need for time or frequency estimation and/or correction.

In one embodiment, the UE 10 is controlled to postpone UL transmission for a first duration comprising the first reference signal, responsive to the timing of the first reference signal occurring during the scheduled transmission pattern. After said first duration, the UE 10 resumes UL transmission according to said transmit pattern. An example of this embodiment is shown in the lower part of FIG. 5.

In some embodiments, the UE 10 may be controlled to postpone UL transmission based on the UL transmission pattern identifies UL transmission with a repetition (R>1). In a variant of this embodiment, if a number of repetitions are scheduled in time slots after the timing 51 of the first reference signal, and that number does not exceed a predetermined value, such as 1, 2, 5, 10 or more, the UE may be configured to drop transmission as predetermined rule. This predetermined rule may be based on the underlying knowledge or assumption that further frequency or time estimation and/or correction will not be required to successfully transmit said remaining repetitions.

In various embodiments, the first duration for which UL transmission is postponed comprises at least one timeslot for the periodic reference signal, i.e. including the timing 51 of the first reference signal. The first duration may further comprise a guard time, in addition to a duration of the first reference signal. Furthermore, the guard time may include pre and/or post switching time(s).

With reference to the described solutions of dropping or postponing, the UE 10 may in various embodiments be configured to control the radio unit 213, based on a control rule and responsive to the timing of the first reference signal occurring during the scheduled transmission pattern, to one of (i) dropping UL transmission according to the scheduled transmission pattern, or (ii) postponing UL transmission for a first duration comprising the first reference signal and subsequently resume UL transmission according to said transmit pattern after said first duration.

As noted, the control rule for controlling of the radio unit 213 to either drop or postpone UL transmission may be based on the number of repetitions of the transmission pattern, in total or scheduled after the colliding reference signal.

Alternatively, or additionally, the control rule may determine the controlling dependent on channel type for the scheduled UL transmission pattern. In one embodiment, based on a collision between the first reference signal and the transmission pattern, the UE 10 controls the radio unit 213 to drop UL transmission based on the UL transmission being is a PUCCH transmission. On the other hand, the UE 10 controls the radio unit 213 to postpone UL transmission based on the UL transmission being a PUSCH transmission. The aforementioned control rule on dropping or postpone the transmission can also be applied for PRACH transmission.

Alternatively, or additionally, the control rule may be dependent on the type of the first reference signal. As noted, the control rule for controlling of the radio unit 213 to either drop or postpone UL transmission may be based on the first reference signal being a TRS, or a CSI-RS (Channel Status Information Reference signal), or other signals.

In various embodiments, one or more of the mentioned rules may be shared by the wireless network and the UE. In other words, the network 100 understands how the UE will act. The UE 10 may thus control its radio unit 213 without specific instruction or approval by the network, to drop or postpone UL transmission. Sharing of the rules may be obtained by the rule in question being prescribed by specification of the wireless system technology, wherein they may be known for both the UE 10 and the base station 130 without the rules having to be signaled. Alternatively, or additionally, the rules may be determined based on information included in or identified by UE capabilities for the UE 10 and stored in the wireless network 100.

In other embodiments, the UE 10 may receive a control message from the wireless network, identifying one or more of the described rules defining how to resolve a situation of a scheduled UL transmission pattern colliding with a reference signal.

The network 100 can thus configure, or agree on, the UE operation, e.g. under what circumstances to drop or postpone UL transmission. This configuration or agreement may e.g. be done in an RRC (Radio Resource Control) configuration.

In one version of the embodiments outlined herein, said first reference signal is transmitted from a serving base station 130, of the wireless network 100, to which the UE 10 is connected. The first reference signal may e.g. be a TRS or CSI-RS. In another version of the embodiments outlined herein, said first reference signal is transmitted from a neighbor base station 140 to the serving base station 130, such as a signal usable for neighbor cell measurements.

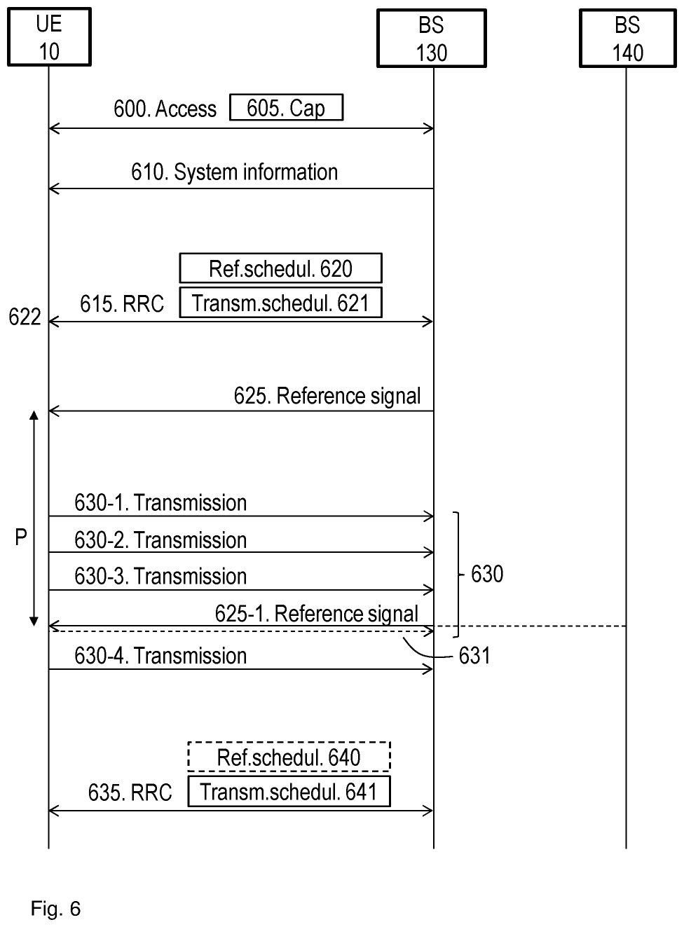

FIG. 6 provides a signaling diagram, in which various of the discussed embodiments are illustrated.

When the UE 10 registers with the wireless network, the wireless network 100 obtains UE capabilities 605 associated with the UE 10. The UE capabilities 605 may be obtained in access communication 600 with the UE 10. Alternatively, the UE 10 may transmit a capability ID to the network 100, which identifies associated UE radio capabilities which may be obtained from a database in or connected to the network 100. Such a capability ID may e.g. be manufacturer-specific and defined by the UE manufacturer or vendor, or PLMN-specific and defined by an operator of the network 100. Various forms of defining and communicating capability IDs may carried out as provided for under the 3GPP concept of RACS (Radio Access Capability Signaling). In various embodiments the UE capabilities identify a UE category, power class or other information associated with the UE 10, based on which the network 100 may determine rules to apply responsive a collision between a DL reference signal and an UL transmission pattern, as outlined. It may be noted that registration of the UE 10 with the wireless network 100 may be carried out in communication with any base station of the wireless network 100. In addition, or as an alternative, to receiving information identifying UE capabilities 605 in access communication 600, such information may be conveyed by the UE 10 to the network 100 at a later stage, e.g. in RRC signaling 615.

The network 100 may be configured to transmit, such as by broadcast, system information 610 for receipt in the UE 10. The system information may include rules, or information based on which the UE 10 shall determine rules, to apply responsive a collision between a DL reference signal and an UL transmission pattern, as outlined.

The UE may be configured to receive 622 information 620 from the wireless network 100, which information 620 identifies scheduling of one or more DL reference signals, usable for estimating a time and/or frequency error of the radio unit. The one or more reference signals may include at least one periodic reference signal, having a period P. This information identifying the reference signals may be obtained in RRC communication 615, as indicated. Alternatively, scheduling of one or more reference signals may be obtained by means of system information 610.

The UE 10 may further receive scheduling 621 of an UL transmission pattern from the wireless network, e.g. through RRC communication 615, when the UE 10 is configured in connected mode with the base station 130.

It shall be noted that the information 620 identifying scheduling of the one or more reference signals and the scheduling information 621 of the transmission pattern need not be provided together or at the same time. The drawing illustrates RRC as a conduit for conveying this information, not as a single and common RRC message or occasion.

The DL reference signals 625 may be periodic, with a period P, provided for receipt in the UE 10 as described, e.g. a TRS or CSI-RS from the serving base station 130, or a reference signal obtained from a neighbor cell base station 140, usable for cell measurement.

Based on the scheduled transmission pattern 621, the UE may carry out repeated transmissions 630. The repeated transmissions may comprise transmission repetitions of the same UL message so that the base station 130 may perform averaging over multiple received repetitions of the same data and thereby improve its reception performance. Additionally, or alternatively, the transmission pattern may comprise scheduling with repeated transmission using semi-persistent scheduling.

The obtained information 620 indicates timing of a first reference signal 625-1 during the scheduled transmission pattern, i.e. within a transmit duration of the scheduled repeated transmissions 630-1 to 630-4. The first reference signal 625-1 may e.g. be a TRS or CSI-RS from the serving base station 130, or a reference signal obtained from a neighbor cell base station 140, usable for cell measurement, as described.

Based on one at least one of the described rules, and responsive to the collision of the scheduled first reference signal 625-1 and the transmission pattern, the UE 10 will either drop or postpone the UL transmission. Here, dropping means ignoring the possibility to transmit, i.e. refraining from transmitting even though scheduled. In the illustrated case, the intended transmission occasion 631 of the fourth transmission collides with the first reference signal 625-1.

When dropping UL transmission, this may involve cancelling all scheduled transmissions 630-1 to 630-4, or only transmissions 631 scheduled in the colliding time slot and subsequent time slots of the transmission pattern, i.e. transmission 630-4 in the shown example. The result may thus be, dependent on situation, that either no UL transmission is carried out, or that only repetitions 630-1 to 630-3 are transmitted, in the shown example.

Subsequently, new scheduling 641 may be received in the UE 10 from the base station 130, which may provide resources for new transmissions, e.g. for dropped UL transmissions.

In an alternative embodiment where postponing UL transmission is carried out, the UL transmission 630-4 which was scheduled in the duration 631 (e.g. time slot) where the first reference signal 625-1 is received, is instead carried out in a later time slot(s) as shown in the drawing, such as in the next time slot. The mechanism to postpone UL transmission to a later time slot(s) is in one embodiment carried out in accordance with a rule known by both network 100 and the UE 10. This rule for how to resolve a situation of collision may be known by specification, or otherwise informed or agreed by signaling between the UE 10 and the base station 130, e.g. in access signaling 600 or RRC 615. This way, the collision situation can be handled with minimal extra signaling.

Referring to the general method as carried out in the UE 10, in various embodiments said first reference signal is an aperiodic first reference signal scheduled prior to the scheduled uplink transmission pattern. This solution is in various embodiments implemented for a UE 10 operating under HD-FDD or TDD.

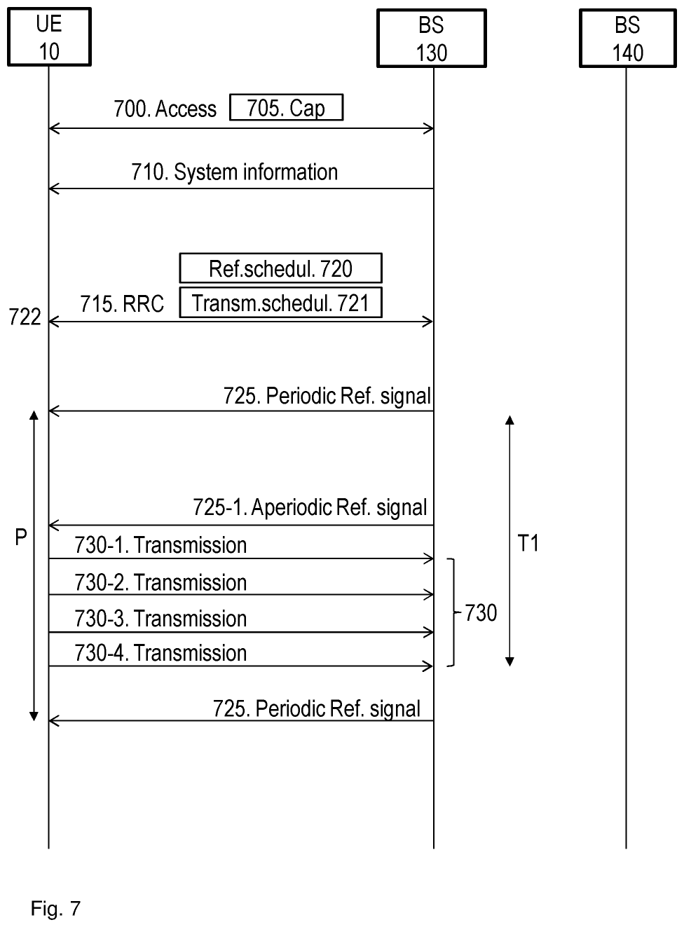

FIG. 7 schematically illustrates a signaling diagram for such embodiments. When the UE 10 registers with the wireless network, the wireless network 100 obtains UE capabilities 705 associated with the UE 10. The UE capabilities 705 may be obtained in access communication 700 with the UE 10. Alternatively, the UE 10 may transmit a capability ID to the network 100, which identifies associated UE radio capabilities which may be obtained from a database in or connected to the network 100. Such a capability ID may e.g. be manufacturer-specific and defined by the UE manufacturer or vendor, or PLMN-specific and defined by an operator of the network 100. Various forms of defining and communicating capability IDs may carried out as provided for under the 3GPP concept of RACS (Radio Access Capability Signaling). In various embodiments the UE capabilities identify a UE category, power class or other information associated with the UE 10, based on which the network 100 may determine rules to apply based on a scheduled UL transmission pattern, as outlined. These rules may determine whether an aperiodic first reference signal shall be scheduled and transmitted from the base station 130, and/or what timing the aperiodic first reference signal shall have with respect to the transmission pattern, and/or on what frequency the aperiodic first reference signal shall be allocated. It may be noted that registration of the UE 10 with the wireless network 100 may be carried out in communication with any base station of the wireless network 100.

The network 100 may be configured to transmit, such as by broadcast, system information 710 for receipt in the UE 10.

The UE may be configured to receive 722 information 720 from the wireless network 100, which information 720 identifies scheduling of one or more DL reference signals, usable for estimating a time and/or frequency error of the radio unit. The one or more reference signals may include at least one periodic reference signal 725, having a period P, such as a TRS, CSI-RS or other. This information identifying the reference signals may be obtained in RRC communication 715, as indicated. Alternatively, scheduling of one or more reference signals may be obtained by means of system information 710.

The UE 10 may further receive scheduling 721 of an UL transmission pattern from the wireless network, e.g. through RRC communication 715, when the UE 10 is configured in connected mode with the base station 130.

It shall be noted that the information 720 identifying scheduling of the one or more reference signals and the scheduling information 721 of the transmission pattern need not be provided together or at the same time. The drawing illustrates RRC as a conduit for conveying this information, not as a single and common RRC message or occasion.

Based on the scheduled transmission pattern 721, the UE may carry out repeated transmissions 730. The repeated transmissions may comprise transmission repetitions of the same UL message so that the base station 130 may perform averaging over multiple received repetitions of the same data and thereby improve its reception performance. Additionally, or alternatively, the transmission pattern may comprise scheduling with repeated transmission using semi-persistent scheduling and/or a combination of thereof.

The transmission pattern 730 may be scheduled at different occasions with respect to the periodic reference signals 725. Alternatively, the UE 10 has not received any scheduling 720 of periodic reference signals. In any of these scenarios, the UE 10 may require a reference signal so as to be able to estimate and possibly apply correction or synchronization of its frequency reference source 215.

In various embodiments, the UE 10 is arranged to transmit information to the network 100, identifying a request for an aperiodic reference signal 725-1. This information identifying a request may be conveyed as UE capability information 705. Alternatively, the information may be provided as a message to the network 100 in RRC. The mechanism to obtain a scheduled aperiodic reference signal 725-1 is in various embodiments thus carried out in accordance with a rule known by both network 100 and the UE 10. This rule for how to resolve a situation of the need for error estimation/correction may be known by specification, or otherwise informed or agreed by signaling between the UE 10 and the base station 130, e.g. in access signaling 700 or RRC 715. This way, the collision situation can be handled with minimal extra signaling.

The information may be identified, in the network 100, as a request for an aperiodic reference signal 725-1 based on parameter values of the conveyed information and a predetermined rule. For example, the network 100 may obtain UE capability information for the UE 10, identifying or corresponding to a predetermined period Te between frequency error estimation occasions, as needed or preferred for the UE 10. Information identifying or corresponding to such a period may be explicitly specified in the UE capability information or identified based on other UE capability information such as a UE category, power class or other parameter, or otherwise identified based on information conveyed from the UE 10 to the network 100, e.g. in RRC.

The base station 130 may thus be configured to schedule the aperiodic reference signal 725-1 based on the obtained information identifying a request for an aperiodic reference signal, in order to assist or accommodate UL transmission by the UE 10 according to the scheduled transmission pattern 730. The aperiodic first reference signal may thus be scheduled based on a rule, wherein the aperiodic first reference signal 725-1 is scheduled with a timing prior to the scheduled transmission pattern 730. Note, transmission pattern 730 may not always be a repeated transmission as shown in FIG. 7. This way, it is ensured that the UE 10, upon receiving the aperiodic reference signal 725-1, will be able to obtain or maintain proper synchronization of its frequency reference 125 during the scheduled transmission pattern 730.

In some embodiments, the aperiodic first reference signal 725-1 may be configured in the same manner as periodic reference signals 725, i.e. having a common character, power etc. as e.g. a periodic TRS or CSI-RS 725 transmitted from the serving base station 130.

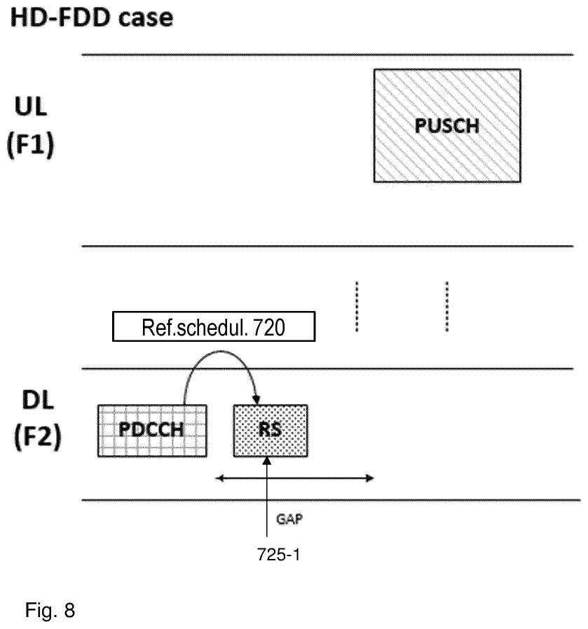

FIG. 8 schematically illustrates a signaling scenario in one embodiment of a HD-FDD configuration of the UE 10. The UE 10 is configured to receive information 720 in the DL on a control channel, such as PDCCH, at a first frequency. The first frequency may be a part of the downlink transmission bandwidth, e.g. a bandwidth part (BWP), a bandwidth supported by the device. The information 720 may be conveyed as DCI (Downlink Control Information), identifying the scheduling of the aperiodic first reference signal (RS) 725-1. The UL transmission pattern is scheduled at a second frequency, e.g. PUSCH. The 720 information identifying the scheduling of the aperiodic first reference signal 725-1 is scheduled at the first frequency in this HD-FDD scenario.

Returning to FIG. 7, in some embodiments, the aperiodic first reference signal 725-1 is scheduled dependent on said rule, such that the aperiodic first reference signal 725-1 is scheduled responsive to a variable time parameter T exceeding the predetermined period Te between frequency error estimation occasions, as needed or preferred for the UE 10. The predetermined period Te may have been conveyed or identified by the UE capability information 705, explicitly or based on information on e.g. UE category. Alternatively, information identifying Te may be conveyed by the UE in RRC 715.

In one embodiment, the time parameter T is or comprises a period T1 between a last received reference signal and an end time of the scheduled UL transmission repetitions. The last received reference signal, in the UE 10, may be a last periodic reference signal 725 (as shown) or a last received aperiodic reference signal. In an alternative embodiment, the time parameter T is or comprises a period P of received periodic DL reference signals.

Various embodiments are adapted to be used in TDD mode.

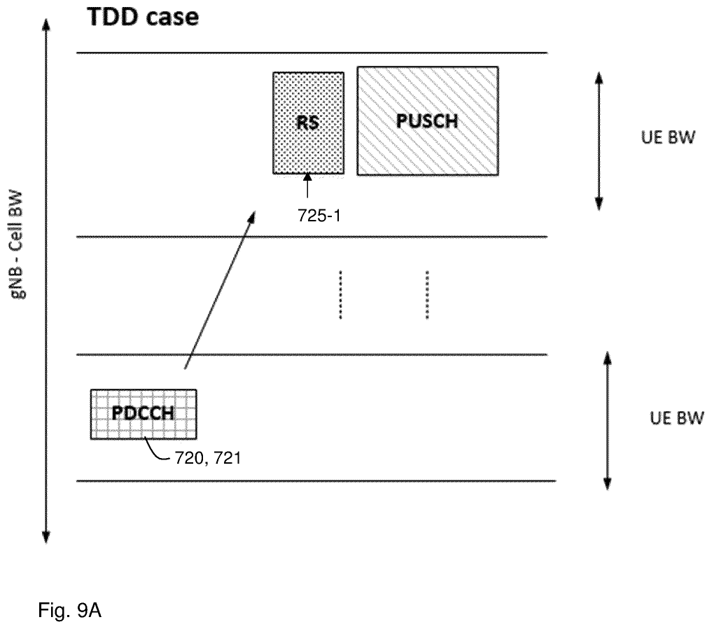

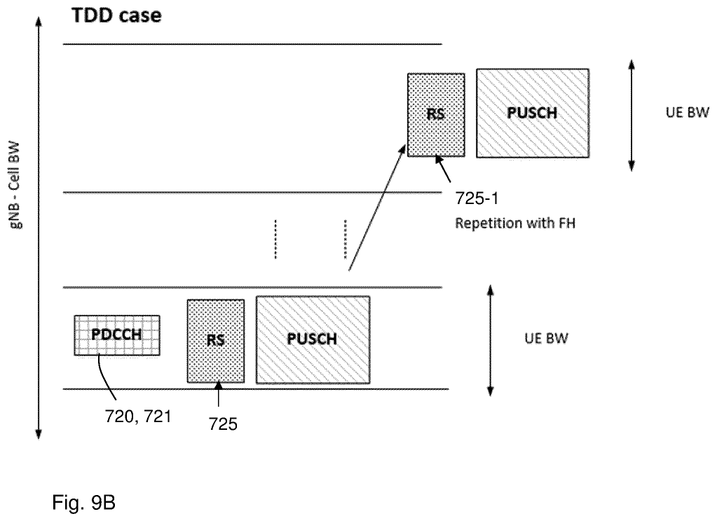

FIG. 9A schematically illustrates a scenario in which the UE 10 is configured to obtain scheduling 720, 721 at a first frequency on a control channel, e.g. PDCCH, and to perform UL transmission using a transmission pattern 730, e.g. on PUSCH, allocated at a second frequency. The UE 10 is operated with limited bandwidth and typically, the UE bandwidth is much smaller than the cell bandwidth, served by a gNB 130. For example, the gNB/cell bandwidth may be 50 MHz and the UE bandwidth only 5 MHz. In such an embodiment, the aperiodic first reference signal 725-1 is scheduled at the second frequency. This way it may be obtained more closely prior to UL transmission according to the transmission pattern 730. In such an embodiment, periodic reference signals 725 may still be scheduled at the first frequency.

FIG. 9B illustrates another scenario, in which the UE 10 is configured to perform UL transmission which require frequency hopping transmission. The UE 10 is also operated with limited bandwidth and typically, the UE bandwidth is much smaller than the gNB/cell bandwidth. For example, the gNB/cell bandwidth is 50 MHz and the UE bandwidth is 5 MHz. In the drawing, this is exemplified by the UL transmission using PUSCH being carried out by frequency hopping between a first frequency within which also the control channel PDCCH is allocated, and a second frequency. In this embodiment, an aperiodic reference signal may be scheduled prior to each UL transmission of a frequency in the frequency hopping. As illustrated, a reference signal 725 is scheduled prior to the UL transmission in the first frequency. This may be a periodic reference signal 725, or alternatively an aperiodic reference signal. Moreover, an aperiodic first reference signal 725-1 is scheduled prior to the UL transmission in the second frequency. Hence, this provides a scenario in which the information identifying scheduling 720, 721 is received at the first frequency, and wherein at least an instance the UL transmission pattern and the aperiodic reference signal 725-1 are scheduled at the second frequency.

In some embodiments, based on said rule, the aperiodic first reference signal 725-1 is scheduled responsive to the first frequency and the second frequency having a separation exceeding a bandwidth supported by the UE. In other words, an aperiodic reference signal 725-1 is configured in the same frequency as the PUSCH if the frequency hopping pattern exceeds the supported bandwidth of the UE 10, as the UE has to switch its center frequency. However, if the frequency hopping pattern is within the supported bandwidth of the UE 10, no aperiodic reference signal is configured, as the UE 10 can reuse e.g. periodic TRS.

Various embodiments have been outlined herein.

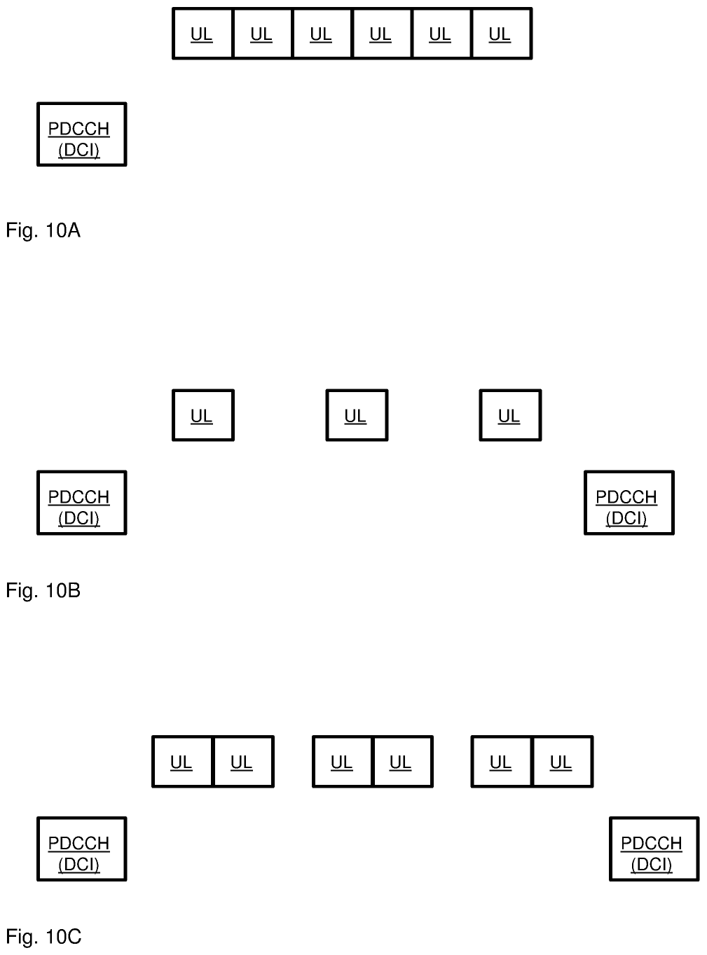

FIG. 10A illustrates one aspect of UL transmission, applicable to the described embodiments, in which UL transmission involves transmission repetitions. The scheduling 621 of the UL transmission pattern 730 is obtained on PDCCH, and UL transmission of repetitions may subsequently be carried out, based on the scheduling 621, on PUSCH. In variants of such embodiments, the scheduling 621 of the transmission pattern 730 identifies a reference timepoint for UL transmission repetitions, and a number of UL transmission repetitions. The reference timepoint is in some embodiments a start time for the UL transmission repetitions. In some variants of those embodiments, the scheduling 621 of said transmission pattern 730 identifies a transmit duration, which transmit duration may identify or comprise a number of timeslots required for said number of UL transmission repetitions, e.g. the six UL repetitions illustrated in FIG. 10A (corresponding to the UL repetitions 630-1 to 630-4 in the example of FIGS. 6 and 730-1 to 730-4 in the example of FIG. 7).

FIG. 10B illustrates another aspect of UL transmission, applicable to the described embodiments, in which UL transmission involves semi-persistent scheduling (SPS) of streaming data. The scheduling/configuration 621 of the UL transmission pattern 730 is obtained on RRC message, and the activation/deactivation can be in PDCCH, and UL transmission occasions of the semi-persistent scheduling may subsequently be carried out, based on the scheduling 621, on PUSCH.

FIG. 10C illustrates another aspect of UL transmission, applicable to the described embodiments, in which UL transmission involves semi-persistent scheduling with repetitions, which combines the aspects described with reference to FIGS. 10A and 10B. In such an embodiment, the scheduling 621 obtained on PDCCH may provide a transmission pattern 730 which involves semi-persistent transmission occasions, wherein each occasion involves transmission repetitions. Each occasion may convey new data, but each repetition within one UL transmission occasion conveys identical data. The scheduling 621 of the UL transmission pattern 730 is obtained on PDCCH, and UL transmission occasions of the semi-persistent scheduling with repetition may subsequently be carried out, based on the scheduling 621, on PUSCH.

In one aspect of the described embodiments, the first reference signal is characterized as a sporadically-on reference signal, as opposed to a reference signal that is characterized as always on.

Various embodiments have been outlined above, and except where they are clearly contradictory, they may be combined in any form. Various of those embodiments are outlined in the following clauses (C):
C1. A method for controlling uplink, UL, transmission, carried out in a user equipment, UE, comprising a radio unit configured for communication with a wireless network, comprising
receiving information from the wireless network, which information identifies scheduling of one or more downlink, DL, reference signals, usable for estimating a time and/or frequency error of the radio unit;
receiving, from the wireless network, scheduling of an UL transmission pattern;
wherein the information indicates timing of a first reference signal prior to or during the scheduled transmission pattern.
C2. The method of C1, wherein said first reference signal is a periodic reference signal.
C3. The method of C2, comprising
dropping UL transmission according to the scheduled transmission pattern, responsive to the timing of the first reference signal occurring during the scheduled transmission pattern.
C4. The method of C2, comprising
postponing UL transmission for a first duration comprising the first reference signal, responsive to the timing of the first reference signal occurring during the scheduled transmission pattern;
resuming UL transmission according to said transmit pattern after said first duration.
C5. The method of C1 or C2, comprising
controlling the radio unit based on a control rule, responsive to the timing of the first reference signal occurring during the scheduled transmission pattern, to one of
   dropping UL transmission according to the scheduled transmission pattern;
   or
   postponing UL transmission for a first duration comprising the first reference signal, and
   resuming UL transmission according to said transmit pattern after said first duration.
C6. The method of C5, wherein said control rule is shared by the wireless network and the UE.
C7. The method of C5, comprising
receiving a control message from the wireless network, identifying said control rule.
C8. The method of any of C5-C7, wherein the control rule determines the controlling dependent on channel type for the scheduled UL transmission pattern.
C9. The method of any of C5-C9, wherein the first duration comprises at least one timeslot for the periodic reference signal.
C10. The method of C9, wherein the first duration comprises a guard time.
C11. The method of any preceding clause, wherein said first reference signal is transmitted from one of
a serving base station, of the wireless network, to which the UE is connected, or
a neighbor base station to the serving base station.
C12. The method of any preceding clause, wherein the UE is configured to carry out said communication in one of full Time Division Duplex, TDD, and half-duplex Frequency Division Duplex.
C13. The method of C1, wherein said first reference signal is an aperiodic first reference signal scheduled prior to the scheduled transmission pattern.
C14. The method of C13, comprising
transmitting information to the network, identifying a request for an aperiodic reference signal, wherein the information identifying scheduling of the aperiodic first reference signal is received responsive to said request.
C15. The method of C14, wherein the information identifying a request for an aperiodic reference signal is transmitted as UE capability information.
C16. The method of any of C13-C15, wherein the aperiodic first reference signal is scheduled based on a rule.
C17. The method of C16, wherein said information is received at a first frequency, and wherein the aperiodic first reference signal is scheduled at the first frequency and the UL transmission pattern is scheduled at a second frequency.
C18. The method of C16 or C17, wherein, dependent on said rule, said information identifies scheduling of the aperiodic first signal responsive to a time parameter T exceeding a predetermined period Te between frequency error estimation occasions.
C19. The method of C18, wherein the time parameter T comprises a period between a last received reference signal and an end time of the scheduled UL transmission repetitions.
C20. The method of C18, wherein the time parameter T comprises a period of received periodic DL reference signals.
C21. The method of C20, wherein said information is received at a first frequency, and wherein the UL transmission pattern and the aperiodic first reference signal are scheduled at a second frequency.
C22. The method of C21, wherein, dependent on said rule, the aperiodic first reference signal is scheduled responsive to the first frequency and the second frequency having a separation exceeding a bandwidth supported by the UE.
C23. The method of any preceding clause, wherein the scheduling of said transmission pattern identifies a reference timepoint for UL transmission repetitions, and a number of UL transmission repetitions.
C24. The method of C23, wherein said reference timepoint is a start time for the UL transmission repetitions.
C25. The method of C23 or C24, wherein the scheduling of said transmission pattern identifies a transmit duration.
C26. The method of C25, wherein said transmit duration comprises a number of timeslots required for said number of UL transmission repetitions.
C27. The method of any preceding clause, wherein the transmission pattern identifies transmission with semi-persistent scheduling.
C28. The method of any preceding clause, wherein said first reference signals is a sporadically-on reference signal.
C29. A user equipment, UE, comprising
a radio unit, and
logic for controlling uplink, UL, transmission with a wireless network, wherein the logic is configured to control the radio unit to
   receive information from the wireless network, which information identifies scheduling of one or more downlink, DL, reference signals, usable for estimating a time and/or frequency error of the radio unit;
   receive, from the wireless network, scheduling of an UL transmission pattern;
wherein the information indicates timing of a first reference signal prior to or during the scheduled transmission pattern.
C30. The UE of C29, wherein the logic is configured to control the radio unit in accordance with any of C2-C28.

1. A method for controlling uplink (UL) transmission, carried out in a user equipment (UE) comprising a radio unit configured for communication with a wireless network, comprising: receiving information from the wireless network, which information identifies scheduling of one or more downlink (DL) reference signals, usable for estimating a time and/or frequency error of the radio unit; receiving, from the wireless network, scheduling of an UL transmission pattern; wherein the information indicates timing of a first reference signal prior to or during the scheduled transmission pattern.

2. The method of claim 1, wherein said first reference signal is a periodic reference signal.

3. The method of claim 2, comprising: dropping UL transmission according to the scheduled transmission pattern, responsive to the timing of the first reference signal occurring during the scheduled transmission pattern.

4. The method of claim 2, comprising: postponing UL transmission for a first duration comprising the first reference signal, responsive to the timing of the first reference signal occurring during the scheduled transmission pattern; resuming UL transmission according to said transmit pattern after said first duration.

5. The method of claim 1, comprising: controlling the radio unit based on a control rule, responsive to the timing of the first reference signal occurring during the scheduled transmission pattern, to one of dropping UL transmission according to the scheduled transmission pattern; or postponing UL transmission for a first duration comprising the first reference signal, and resuming UL transmission according to said transmit pattern after said first duration.

6. The method of claim 5, wherein said control rule is shared by the wireless network and the UE.

7. The method of claim 5, comprising: receiving a control message from the wireless network, identifying said control rule.

8. The method of claim 5, wherein the control rule determines the controlling dependent on channel type for the scheduled UL transmission pattern.

9. The method of claim 5, wherein the first duration comprises at least one timeslot for the periodic reference signal.

10. The method of claim 9, wherein the first duration comprises a guard time.

11. The method of claim 1, wherein said first reference signal is transmitted from one of a serving base station, of the wireless network, to which the UE is connected, or a neighbor base station to the serving base station.

12. The method of claim 1, wherein the UE is configured to carry out said communication in one of full Time Division Duplex (TDD) and half-duplex Frequency Division Duplex (FDD).

13. The method of claim 1, wherein said first reference signal is an aperiodic first reference signal scheduled prior to the scheduled transmission pattern.

14. The method of claim 13, comprising: transmitting information to the network, identifying a request for an aperiodic reference signal, wherein the information identifying scheduling of the aperiodic first reference signal is received responsive to said request.

15. The method of claim 14, wherein the information identifying a request for an aperiodic reference signal is transmitted as UE capability information.

16. The method of claim 13, wherein the aperiodic first reference signal is scheduled based on a rule.

17. The method of claim 16, wherein said information is received at a first frequency, and wherein the aperiodic first reference signal is scheduled at the first frequency and the UL transmission pattern is scheduled at a second frequency.

18. The method of claim 16, wherein, dependent on said rule, said information identifies scheduling of the aperiodic first signal responsive to a time parameter T exceeding a predetermined period Te between frequency error estimation occasions.

19. The method of claim 18, wherein the time parameter T comprises a period between a last received reference signal and an end time of the scheduled UL transmission repetitions.

20. The method of claim 18, wherein the time parameter T comprises a period of received periodic DL reference signals.

21-30. (canceled)
